(19) United States
(12) Patent Application Publication
(10) Pub. No.: US 2013/0236265 A1
(43) Pub. Date: Sep. 12, 2013

(54) SELF-LOCKING NUT

(71) Applicants: Frank-Uwe Diener, Tuttlingen (DE); Wolfgang Giraud, Nürnberg (DE); Siegfried Oberndorfer, Gerabronn (DE); Thorsten Schraer, Gerolsbach (DE)

(72) Inventors: Frank-Uwe Diener, Tuttlingen (DE); Wolfgang Giraud, Nürnberg (DE); Siegfried Oberndorfer, Gerabronn (DE); Thorsten Schraer, Gerolsbach (DE)

(73) Assignee: RUIA GLOBAL FASTENERS AG, Neuss (DE)

(21) Appl. No.: 13/885,959

(22) PCT Filed: Nov. 24, 2011
(86) PCT No.: PCT/DE2011/050050

§ 371 Date: May 16, 2013

(30) Foreign Application Priority Data
Nov. 29, 2010 (DE) 20 2010 015 819.2

(51) Int. Cl. F16B 39/30

(52) U.S. Cl. CPC F16B 39/30
USPC 411/307

(57) ABSTRACT

The invention relates to a self-locking nut (10) having an internal thread (12) with a core hole which has one or a plurality of regions (14) having a reduced internal diameter.

### TECHNICAL FIELD

The present invention relates to a self-locking nut which is also referred to as a “clamping nut”, having a core hole and thread taps.

### PRIOR ART

Self-locking nuts of this kind according to the prior art have various disadvantages. So-called “squeeze-lock nuts”, in which the thread, the hexagonal outer shape or a small cone at the top are squeezed at two or more places, have the disadvantage that they require an additional manufacturing stage and that clamping is not sufficient if it is only squeezed in two places.

A further solution from the prior art consists in the so-called three-cone clamping nut, having three cones at the top, these being bent inwards to produce the clamping effect or the increased loosening torque. As a general rule, all these self-locking nuts from the prior art tend to seize up, or, in other words, they cannot be screwed down properly or cannot be unscrewed, or at least not without damage, after tightening once.

So-called “Polystop” nuts are another alternative from the prior art. These have a plastic ring at the top which creates the clamping effect. The use of an additional component, especially one made from a different material, makes this a very costly solution. Most of these self-locking clamping nuts from the prior art also have the disadvantage that they are taller than standard nuts and therefore require more space during use and longer screws or bolts, thus resulting in additional costs.

To summarise, it can be stated that all the existing clamping nuts or self-locking nuts are a compromise between ideal self-locking, minimum seizing up, minimum height and low manufacturing costs. All such nuts from the prior art are a more or less satisfactory compromise with regard to these objects. None of the self-locking nuts from the prior art mentioned above are an optimum solution to all four objects.

### DESCRIPTION OF THE INVENTION

The object of the present invention is therefore to create a self-locking nut of this type or clamping nut of this type which can be produced without additional outlay, does not have additional space and weight requirements, does not seize up and still has a good clamping effect.

This object is achieved according to the invention by a self-locking nut or clamping nut having a core hole with a reduced internal diameter in one or more regions.

Alternatively, the regions between the thread taps in one or more parts of the internal thread may not be flattened, but formed such that they extend to a pointed burr which protrudes above the remaining internal thread.

A clamping nut of this kind according to the invention has the following advantages: the manufacturing costs are lower and may be similar to the manufacturing costs for a standard nut without clamping or self-locking properties, as additional material and additional processing stages are not required to achieve the clamping effect.

According to the invention, the clamping effect may also be achieved during cold forming or during thread cutting.

Nuts according to the invention weigh less and have a lower overall height than cone clamping nuts. They therefore do not require such long screws or bolts and do not require additional space during use.

The clamping nuts according to the invention also have a significantly better clamping effect, as clamping is not applied diagonally and finally self-locking nuts according to the invention have little or no tendency to seize up.

According to the invention it is particularly preferable to provide three regions with a reduced core hole internal diameter which are spaced equally apart over the core hole circumference. This makes it possible to achieve an optimum and even clamping effect.

It is preferably sufficient for the regions with a reduced core hole internal diameter to respectively only extend over a small portion of the circumference of the core hole of preferably 10 to 15 degrees. This thus prevents the screw connection seizing up, although an adequately high clamping effect can still be achieved.

It is also preferable if the regions with a reduced core hole diameter are only applied in the last three to four thread turns of the internal thread, or, in other words, away from the side on which the nut is screwed in. The nut only clamps when it is almost completely screwed on to the screw or bolt.

The regions with a reduced core hole diameter may preferably be formed by flat sections on the internal diameter of the core hole. The nut according to the invention is thus particularly easy to manufacture as the core hole is nowadays usually produced by extruding and an extrusion die with corresponding flattened areas only needs to be used at the end of the nut away from the workpiece. Apart from one-off reconstruction of the tool, or, in other words, the die, there are no further costs associated with manufacturing the nut according to the invention.

An improved clamping effect, although with a somewhat more complicated tool manufacturing process, is achieved by forming the regions with a reduced core hole diameter by means of sections on the circumference of the core hole which are slightly curved inwards.

To further reduce the tendency of the clamping nut to seize up, it is preferable to form the transition from the normal core hole circumference to the regions with a reduced internal diameter by small radii.

In the alternative embodiment of the invention it is preferable to provide three regions in the form of pointed burrs at equal intervals over the circumference of the internal thread. This thus ensures that the clamping effect when screwing in is as even as possible.

The regions in the form of pointed burrs preferably only extend over a small portion of the circumference of the internal thread in each case, as this can lead to a further reduction in the tendency to seize up.

It is also preferable if the regions in the form of pointed burrs only extend between the last three to four thread taps of the internal thread, or, in other words, away from the workpiece side of the nut. The nut thus only clamps when it has been screwed sufficiently far onto the bolt.

A particularly favourable manufacturing process is achieved if the regions in the form of pointed burrs are manufactured by forming the adjacent thread taps such that they are deeper or wider when manufacturing the thread using non-cutting techniques. This causes more material to be thrown up which can then form the pointed burr.

### BRIEF DESCRIPTION OF THE DRAWINGS

The present invention is explained in greater detail below with the aid of the embodiment illustrated in the drawings. In these drawings:

FIG. 1 shows a sectional view of a clamping nut according to the invention;

FIG. 2 shows the clamping nut from FIG. 1 from above;

FIG. 3 shows the clamping nut from FIG. 1 from the side and along line A-A in FIG. 4 in section with a detailed representation of the internal thread;

FIG. 4 shows the clamping nut from FIG. 1 from above with a bolt screwed in and cut to the height of the nut;

FIG. 5 shows the view from FIG. 3 with the bolt screwed in;

FIG. 6 shows detail X from FIG. 5.

### BEST MEANS OF EMBODYING THE INVENTION

FIG. 1 shows a clamping nut or self-locking nut 10 according to the invention from the side in a sectional view. In this case the internal thread 12 is not shown in any further detail in accordance with customary drawing standards. However, those regions 14 in which the core hole diameter is reduced, or higher burrs are provided between the thread taps are shown. As illustrated, these regions 14 extend over barely half the length of the internal thread of the nut 10 and usually cover three to four thread turns.

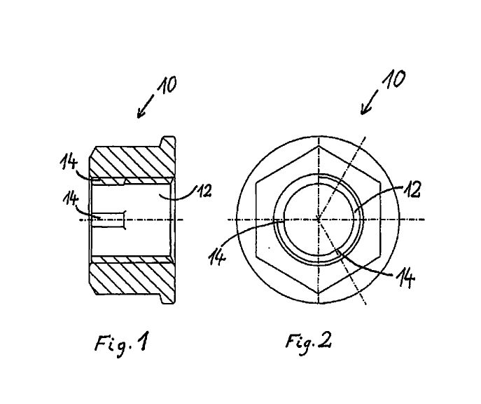

FIG. 2 shows the nut from FIG. 1 from above, clearly showing the internal thread 12 and the regions 14 with a reduced core hole diameter or higher burrs between the thread taps. FIG. 2 shows clearly that three regions 14 with a reduced core hole diameter or higher burrs between the thread taps are provided in the present embodiment, these regions being equally spaced and distributed over the thread circumference so that the spacing between the individual regions 14 is 120 degrees in each case.

It is also very easy to see that the regions 14 each only relate to a very short curved section of the thread of approximately 10 to 15 degrees.

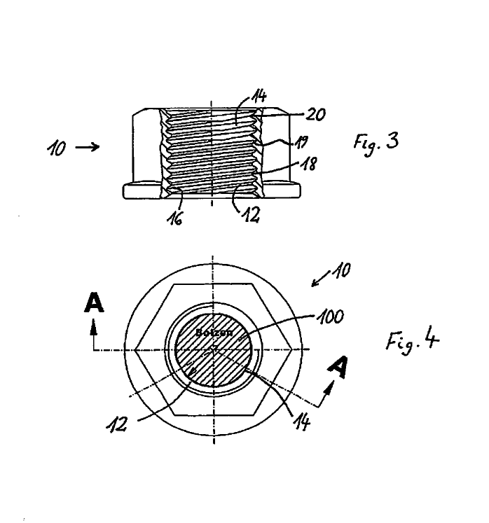

FIG. 3 shows the nut from FIG. 1 in partial section along line A-A in FIG. 4 with a detailed view of the internal thread 12. In this FIG. 3, the region 14 shown at the top right of the picture with the different shaped thread according to the invention can be seen quite clearly. A standard internal thread 12 is shown in the lower region of the illustrated nut 10, or, in other words, on the side of the nut with which the nut is screwed onto a bolt, or from which a screw is screwed into the nut. As usual, this consists of V-shaped taps 16 between which flattened portions 18 extend, these sections lying on the lateral surface of a cylinder with the core hole diameter when viewed in geometric terms.

On the other hand, the sides 19 of the V-shaped taps 16 are extended in the region 14 and meet in a pointed burr 20 which therefore protrudes into a notional cylinder with the core hole diameter.

FIG. 4 shows the clamping nut or self-locking nut 10 according to the invention, a bolt 100 being screwed in at this point, this being shown cut to the height of the top end of the nut 10. Once again the regions 14 with the reduced core hole diameter can clearly be seen in this case. It is also very clear that the core hole diameters of the bolt 100 and the nut 10 coincide in the region 14, thus leading to the desired clamping effect according to the invention.

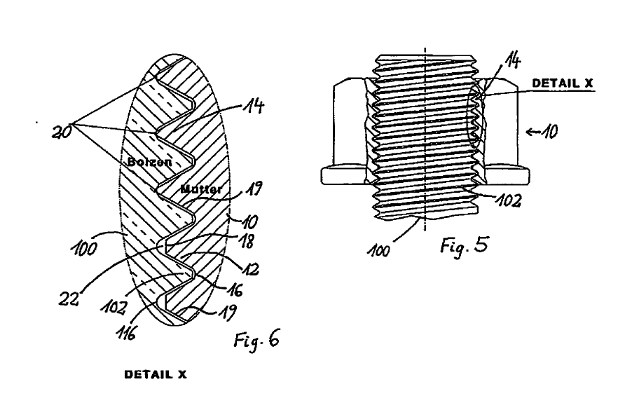

FIG. 5 also shows the combination of a nut 10 and bolt 100 illustrated in FIG. 4, the nut once again being shown along line A-A in FIG. 4 and in partial section as in FIG. 3. To facilitate understanding, the bolt 100 is not shown in section so that the outer thread 102 of the bolt can be clearly seen. The bolt 100 can be a commercially available bolt and may comply with the usual technical standards. Interlocking according to the invention of the outer thread 102 of the commercially available bolt 100 with the region 14 modified according to the invention of the internal thread 12 of the nut 10 is shown in greater detail as detail X in FIG. 6. The internal thread 102 of the bolt 100 is also shown in section in this case to illustrate the clamping effect according to the invention more clearly. The region of the internal thread 12 of the nut 10 which is configured as normal, or, in other words, according to the prior art, is shown in the bottom region of detail X so that the difference compared to the configuration of regions 14 of the internal thread 12 according to the invention stands out more clearly.

The bottom two thread turns of the internal thread 12 of the nut 10 in FIG. 6 are actually configured as normal in accordance with the prior art, whilst the upper three thread turns illustrated in FIG. 6 have a reduced core hole diameter. As is very clearly visible in FIG. 6 in this case, the sides 19 of the V-shaped thread taps 16 normally end in a flattened region 18 which separates the individual thread taps 16 and which region has a surface which corresponds to the lateral surface of a cylinder with the standard core hole diameter. In this way, the play 22 required to screw the bolt 100 into the nut 10 with minimal friction can be guaranteed over the entire thread length. The sides 19 of the nut thread are pressed against the opposite sides of the bolt under normal circumstances when using non-self-locking nuts only if there is a pre-tensioning force acting between the bolt 100 and the nut 10, and the resulting friction maintains the screw connection.

The plateau-type region 18 between the individual thread turns 16 of the internal thread 12 of the nut 10 is not present in the upper region of detail X, or, in other words, in the top three thread turns shown. Instead, the sides 19 of the individual thread taps 16 in this region 14 merge over just a very small radius, thus forming protruding burrs 20 between the thread taps 16.

These burrs 20 compulsorily occur, as is clearly shown in FIG. 6, due to the geometric conditions in contact with the bottom of the thread taps 116 of the outer thread 102 of the bolt 100. The theoretical geometric conditions are shown in FIG. 6. The region of the burrs 20 shown in black in this respect is of course not actually present, but the burrs 20 are elastically deformed in this region by the contact pressure at the bottom of the taps 116 of the bolt 100. The burrs 20 are thus actually slightly “flattened”, and simultaneously penetrate the bottom of the taps 116 of the outer thread of the bolt 100. As this effect occurs simultaneously from a number of sides, clamping of the screw connection and thus self-locking are achieved irrespective of whether a pre-tensioning force was applied when screwing in. In order to achieve as symmetrical as possible a clamping force and avoid the nut wobbling, two or more, or preferably three evenly spaced regions 14 are provided over the circumference of the internal thread 12 of the nut 10 according to the invention.

The regions 14 may be produced in different ways according to the invention:

On the one hand, nuts are nowadays usually manufactured by cold forming, dies with the core hole diameter being pressed in from above and below, after which the thread is cut, milled or rolled. During milling or rolling, a slightly smaller die diameter may optionally be selected, since the material extruded when forming the thread taps 16 is displaced into the regions 18 between the thread taps during a non-cutting manufacturing of the internal thread 12 of the nut 10.

According to the invention the regions 14 can be manufactured simply by grinding down or hollowing out these regions on the die acting on the nut from above. A region 14 in the form of a secant, or, in other words, a flat region or, even more preferably according to the invention, as is also shown here, a region 14 which is curved inwards can thus be manufactured. This inwards curve is particularly preferable to avoid the thread seizing up in the clamped state.

The curvature is preferably defined from the outside by a large radius.

Alternatively, when using a non-cutting method to manufacture the internal thread 12, the regions 14 can be produced by creating the thread taps 16 of the internal thread 12 such that they are deeper and/or wider in the region 14, thus causing more material to be deformed and accumulating correspondingly higher burrs between the individual thread turns.

In both cases, manufacturing a clamping nut according to the invention is no more costly or complex than manufacturing a commercially available nut without any clamping effect. Only the manufacturing tools, or, in other words either the dies for producing the core hole or the tools for rolling or milling the thread need to be designed differently as a one-off procedure.

1. A self-locking nut (10), said nut comprising: an internal thread (12) with a core hole, wherein the core hole of the nut (10) has one or more regions (14) with a reduced internal diameter.

2. The self-locking nut (10) according to claim 1, wherein the one or more regions (14) with a reduced core hole internal diameter are provided and spaced equally over a circumference of the core hole.

3. The self-locking nut (10) according to claim 1, wherein the one or more regions (14) with a reduced core hole internal diameter extend over a small section of a circumference of the core hole of preferably between 10 to 15° in each case.

4. The self-locking nut (10) according to claim 1, wherein the one or more regions (14) with a reduced core hole internal diameter merely extend over last three to four thread turns of the internal thread (12) or, away from a side on which the nut (10) is screwed in.

5. The self-locking nut (10) according to claim 1, wherein the one or more regions (14) with a reduced core hole internal diameter are formed by flat portions on the internal diameter of the core hole.

6. The self-locking nut (10) according to claim 1, wherein the one or more regions (14) with a reduced core hole internal diameter are formed by sections on the internal diameter of the core hole being curved slightly inwards.

7. The self-locking nut (10) according to claim 1, wherein, a transition from a normal core hole circumference to the one or more regions (14) with the reduced internal diameter is formed by small radii.

8. A self-locking nut (10) having an internal thread (12) with thread taps (16), said nut comprising: regions (18) between the thread taps (16) that are not flattened in one or more sections (14) of the internal thread (12), but are formed to extend to a pointed burr (20) which protrudes inwards above a remaining internal thread (12).

9. The self-locking nut (10) according to claim 8, wherein three regions in the form of pointed burrs (20) are provided and spaced equally over a circumference of the internal thread (12).

10. The self-locking nut (10) according to claim 9, wherein the regions in the form of pointed burrs (20) only extend over a small section (14) of the circumference of the internal thread (12) in each case.

11. The self-locking nut (10) according to claim 9 wherein the regions in the form of pointed burrs (20) only extend between last three to four thread taps (16) of the internal thread (12), or away from a workpiece side of the nut (10).

12. The self-locking nut (10) according to claim 9, wherein the regions in the form of pointed burrs (20) are manufactured by forming adjacent thread taps (16) deep and/or wide when the internal thread (12) is manufactured using a non-cutting technique.
